(19) United States
(12) Patent Application Publication
(10) Pub. No.: US 2003/0046319 A1
(43) Pub. Date: Mar. 6, 2003

(54) Editing system and method for developing visual Web programs and recording medium stored with visual Web program editing software

(76) Inventor: Sho-Huan Simon Tung, Yunlin (TW)

Correspondence Address: BIRCH STEWART KOLASCH & BIRCH, PO BOX 747, FALLS CHURCH, VA, 22040-0747, US

(21) Appl. No.: 09/765,668

(22) Filed: Jan. 22, 2001

(51) Int. Cl. G06F 17/24

(52) U.S. Cl. 707/530

(57) ABSTRACT

The invention provides a Visual Web Program editing system and the corresponding method, which can display the flowchart of a Web application program for sending HTML documents through a browser or electronic mail (E-mail). They can effectively combine both high-level flowchart designs and low-level program editing so that a programmer can use the icons on the flowchart to open HTML or program editor to write an HTML document or program code. The invention effectively integrates flowchart analyses, HTML document designs, and program coding so that program-maintenance engineers can follow the program flowchart to quickly identify the program code for a specific step, simplifying the reading, understanding and maintenance of the programs. The invention further provides a recording medium stored with Visual Web Program editing software.

### BACKGROUND OF THE INVENTION

1. Field of Invention

The invention relates to a Web program editing system, the method thereof, and its recording medium and, more particularly, to a visual Web program editing system, method, and its recording medium that aid the development of Web programs by integrating flowcharts and program texts.

2. Related Art

Due to the rapid development of the Internet, many Web-related technologies have matured. These technologies include the electronic mail (E-mail), HTML, HTTP servers, and browsers. Many software programs have utilized these technologies to transmit information, to display user interfaces, and to interact with users. The Internet and its relevant standards has become the mainstay for running new application programs.

One feature of Web application programs is that the interaction of Web application programs with users is performed by

sending an HTML document containing a data-input form to a user through a browser or E-mail;

sending the next page by the Web application program after the user gives a response; and

repeating this transmission and response procedure until the interaction with the user is finished.

Therefore, the transmission order and destination of HTML documents constitute the main logical structure of Web application programs.

Current Web programming technologies include Common Gateway Interface (CGI), HTML-embedded programming languages (embedding programming language statements in an HTML document through special tags), Server APIs (application programming interface provided by Web servers), and integrated development environments. Nonetheless, none of these provides the function of using flowcharts to integrate logical design and program editing steps in a way that assigns execution steps of a flowchart to program codes associated with the steps. Therefore, the high-level flowcharts and their associated programs cannot be explicitly illustrated, increasing the cost and complexity of Web applications.

Accordingly, how to provide a simple way for programmers to integrate flowcharts and program texts to develop a new kind of Visual Web Programs to decrease the cost and complexity of developing Web applications is indeed an urgent problem to be studied and solved.

### SUMMARY OF THE INVENTION

In view of the foregoing, it is an objective of the invention to disclose a Visual Web Program editing system, a method thereof and a recording medium stored with Visual Web Program editing software that can provide a simple method for programmers to write Visual Web Programs (hereinafter as VWP) to decrease the complexity and lower the developing cost of Web applications.

The invention employs five icons to represent the attributes, transmission methods, and data-processing procedures needed for HTML documents and uses the connections among these icons to draw a flowchart of a program. In addition, these icons are further used as options such as pull-down menus or directory folders to open relevant HTML files, program code files, and receiver files so that programmers can effectively integrate flowchart designs and program coding steps. The icons are also helpful for subsequent program-maintenance engineers to understand the flowchart of the program and quickly find the file of relevant steps so that they can modify the operational details of each step.

### BRIEF DESCRIPTION OF THE DRAWINGS

FIG. 1 is a constitutional block diagram of the disclosed VWP editing system;

FIG. 2 is another constitutional block diagram of the disclosed VWP editing system;

FIG. 3 illustrates a preferred embodiment of the disclosed VWP editing system;

FIG. 4 illustrates another preferred embodiment of the disclosed VWP editing system;

FIG. 5 displays a procedural diagram of the disclosed VWP editing method; and

FIG. 6 displays another procedural diagram of the disclosed VWP editing method.

### DETAILED DESCRIPTION OF THE INVENTION

Before explicitly describing the invention, one should first understand that HTML documents can be categorized into two types depending on responses from users: (1) forms that require user's responses and (2) notifications that do not require responses. According to the transmission methods, the HTML documents can also be classified into two types: (1) those transmitted through a browser and (2) those transmitted by E-mail. Furthermore, to add data-processing units needed for performing merge, delay, or other functions in a flowchart, the disclosed VWP editing system and method include five icons that represent different steps: (1) Browser Form icon, (2) E-mail Form icon, (3) Browser Notification icon, (4) E-mail Notification icon, and (5) Data Processing icon. Of course, the Browser Form icon and the Browser Notification icon can be combined into a Browser icon, and the E-mail Form icon and the E-mail Notification icon can be combined into an E-mail icon.

The above-mentioned icons require some actual contents in order to completely and explicitly explain their functions. Aside from the step names, each of these icons contains different combinations of three contents. These three contents are: (1) a program written in some HTML-embedded programming language (hereinafter also referred as FORM); (2) a description (file) with the addresses of FORM receivers (hereinafter also referred as Receiver); and (3) a data-processing program written in a programming language (hereinafter also referred as DP). How to name the icon, icon style, FORM, Receiver, and DP is not important (namely, the icons shown in the specifications are for demonstration purposes only), while the meanings represented by the icons, FORM, Receiver and DP and the content combination of the icons are the main points of the invention. The icons and the content combinations needed are as follows:

| | |
|---|---|
| Browser Form Icon (CONTENTS: STEP NAME, FORM, DP) | 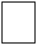 |
| E-mail Form Icon (CONTENTS: STEP NAME, FORM, Receiver, DP) | 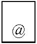 |
| Browser Notification Icon (CONTENTS: STEP NAME, FORM) | 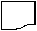 |
| E-mail Notification Icon (CONTENTS: STEP NAME, FORM, Receiver) | 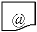 |
| Data Processing Icon | 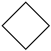 |

Visual Web Program Editing System

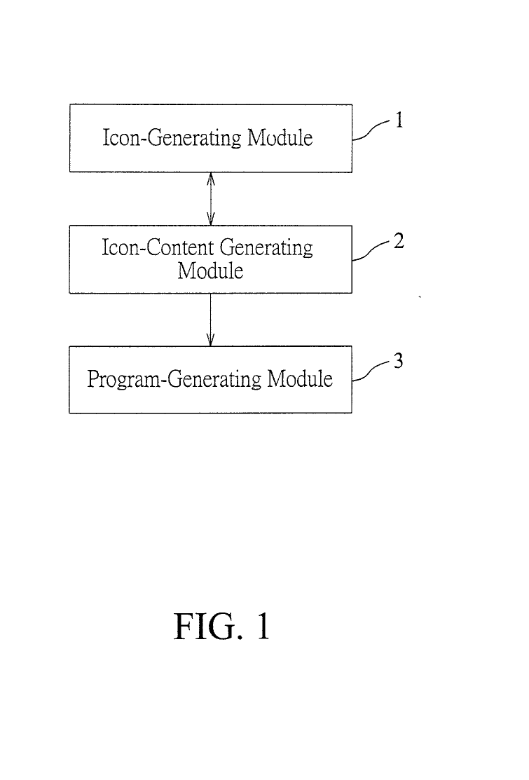

With reference to FIG. 1, the disclosed VWP editing system includes an icon-generating module 1, an icon-content generating module 2, and a program-generating module 3.

The icon-generating module 1 generates at least one icon. In this embodiment, the icon-generating module 1 can generate the above-mentioned Browser Form icons, E-mail Form icons, Browser Notification icons, E-mail Notification icons, and Data Processing icons.

The icon-content generating module 2 generates contents of the icons. The content includes the name and the combination of the FORM, the Receiver, and the DP. The combination of the FORM, the Receiver, and the DP will be further described in detail later.

The program-generating module 3 generates a Web program according to the contents generated by the icon-content generating module. In short, a Visual Web Program is developed using the icons and their content files.

The reason why the Browser Form icon and the E-mail Form icon contain the DP is that the user has to enter data in all forms and replies, and the DP is the program for processing this response. After this processing, the program code in the DP has to determine one or more than one of the steps needed to be continued. The reason why the Browser Notification icon and the E-mail Notification icon do not have the DP is that all notifications do not require responses from the user and therefore do not need to process any data. The reason why the Browser Form icon and the Browser Notification icon do not have the Receiver is that such forms and notifications are transmitted to browsers. Similarly, the reason why both the E-mail Form icon and the E-mail Notification icon have the Receiver is that such forms and notifications are sent via E-mail. The reason why the Data Processing icon only needs the DP is that there is no HTML document to be transmitted in such steps, and therefore, the Receiver is not required.

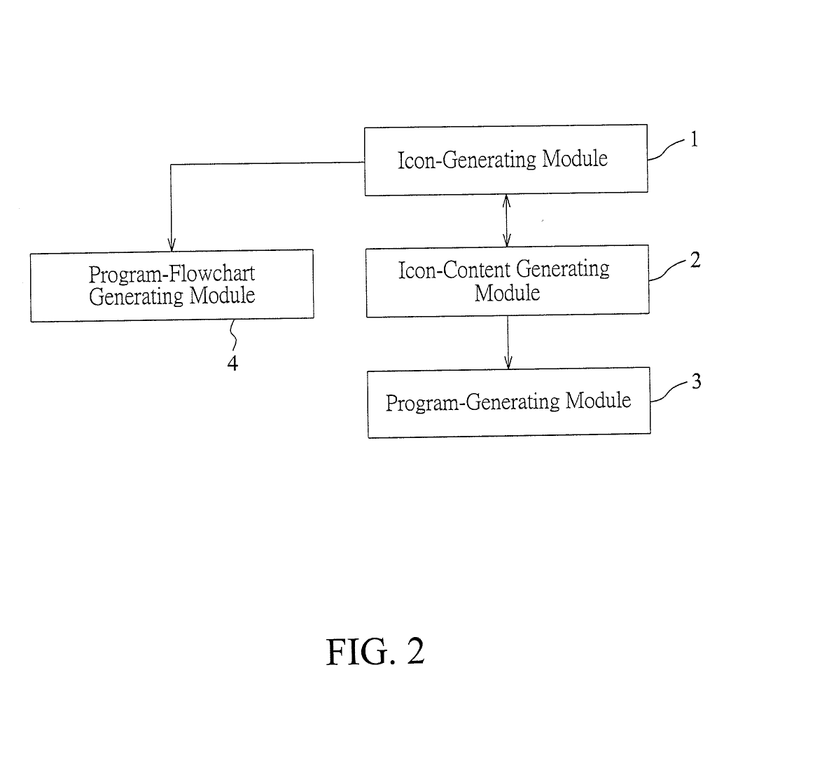

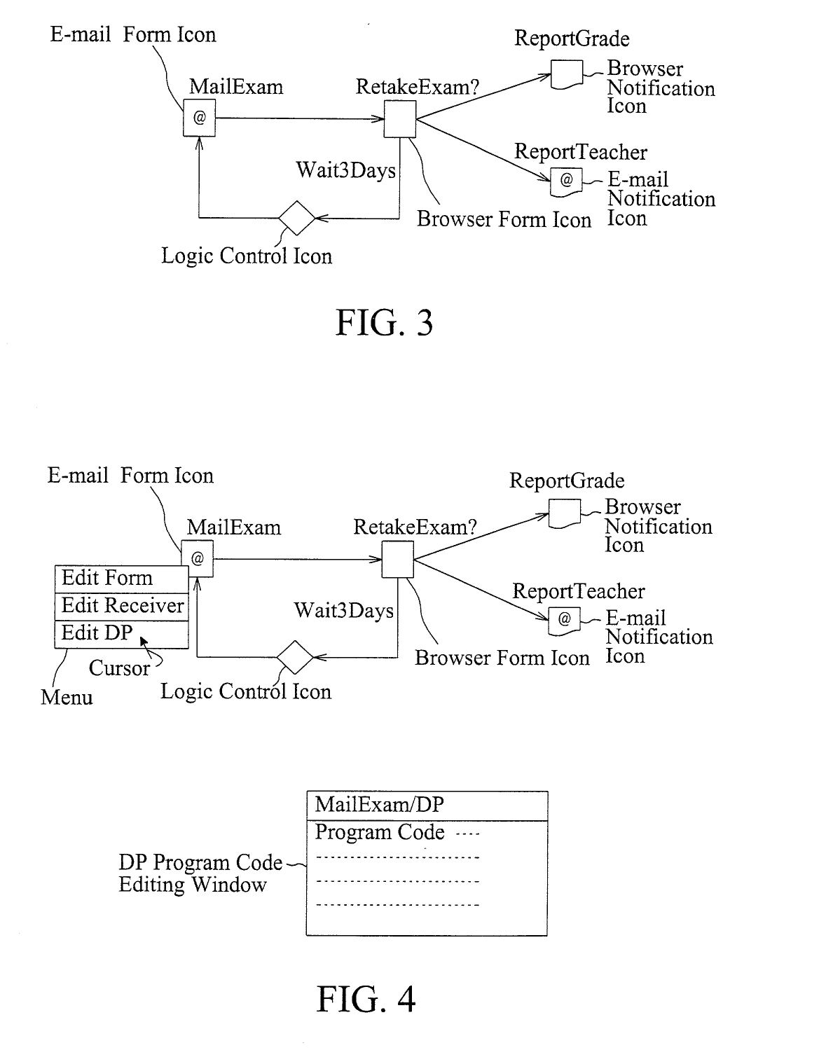

With reference to FIG. 2, the system can further include a program-flowchart generating module 4, which uses the icons generated by the icon-generating module 2 to create a flowchart for a Visual Web Program (FIG. 3).

Embodiment

A programmer can use these five icons and the connections among the icons to indicate the directions in which a Web application program transmits HTML documents. When the program is executed, the actual control logic is determined by program codes written in DPs. An explicit example is as follows:

Suppose a Web-examination system has the following demands:

test problems are sent to a student via E-mail;

after the test, the student can select whether to take the test again;

if he chooses not to, the score, according to the answers given by the student, are calculated by a program, displayed on the student's browser and sent to his teacher at the same time; and

if the student wants to take the test again, then the test problems will be sent to the student three days later.

FIG. 3 illustrates the flowchart of the Visual Web Program for such a Web-examination system using the five icons.

In case of flowchart production or program-code development, a programmer can use a mouse and keyboard to edit the flowchart. As shown in FIG. 4, when the cursor points to a particular icon, the programmer can select from a pull-down menu or directory folder that displays the FORM, Receiver, or DP file of the icon to be edited to continue content-editing and complete the editing of the whole program.

If the contents needed in each step are stored in files, then the above program has the following files, which can be stored in a directory named by the Web-examination program.

MailExam/FORM: This file stores test problems written in an HTML-embedded programming language. Its attribute is a form.

MailExam/Receiver: This file is a text file containing the description of the E-mail address of a student.

MailExam/DP: This file is a program written in a programming language. Its job is to send the name (RetakeExam?) of the next step to be executed to the executing environment of the VWP.

RetakeExam?/FORM: This file is written in an HTML-embedded programming language. It provides the options for the student to retake the exam or not. Its attribute is a form.

RetakeExam?/DP: This file is written in a programming language. Its function is to determine whether the student wants to retake the exam. If the student wants to retake the exam, it returns “Wait3Days” to the executing environment of the VWP. If he chooses not to, it will calculate the score according to the answers provided by the student, stores the score in a database, and returns “ReportGrade” and “ReportTeacher” to the executing environment of the VWP.

ReportGrade/FORM: This file is an HTML embedded program that can retrieve the student score calculated by the RetakeExam?/DP from the database. Its attribute is a notification.

ReportTeacher/FORM: This file is also an HTML embedded program that can retrieve the student score calculated by the RetakeExam?/DP from the database. Its attribute is a notification.

ReportTeacher/Receiver: This file is a text file containing the description of the teacher's E-mail address.

Wait3Days/DP: This file is written in a programming language. Its function is to send the next step (MailExam) to the executing environment of the VWP after three days.

After the programmer finishes editing these files, the files can be provided to the executing environment of the VWP to execute the steps instructed. One should notice that the so-called VWP run-time environment (VRTE) refers to a client-server environment. The client sends out a request to the VRTE for running a particular step. After the VRTE runs this step and all of the subsequent steps needed, it returns a form or a notification to the client. The request and response can be processed through a browser that can also receive E-mail messages or an E-mail reader that can also interact with a browser

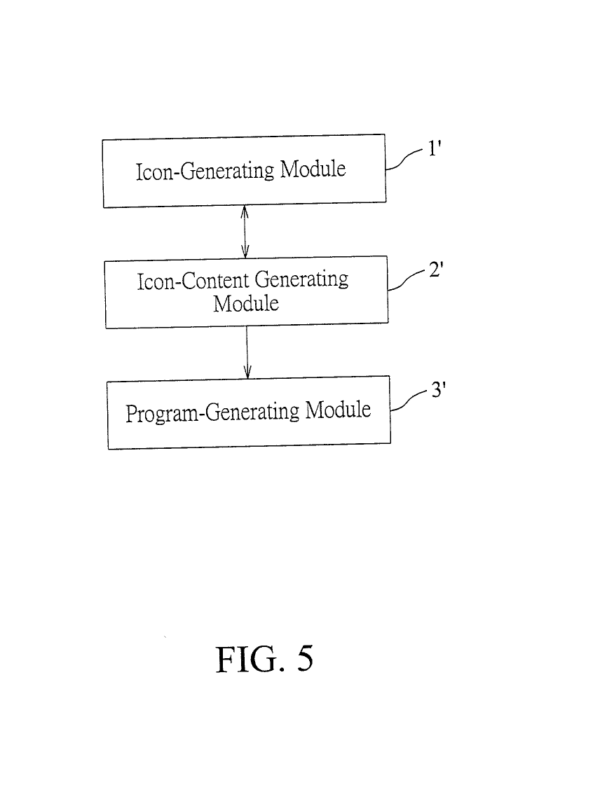

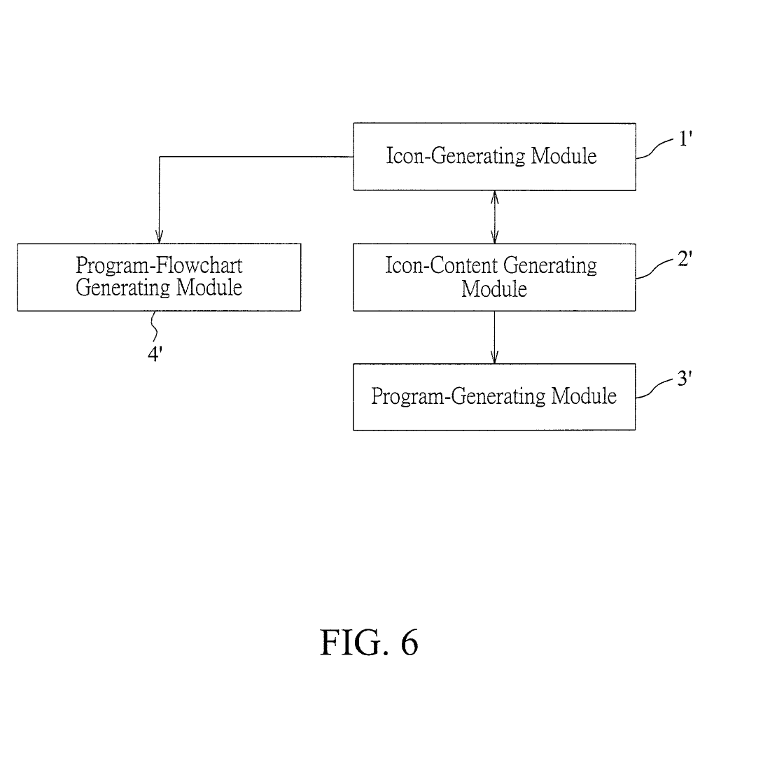

Visual Web Program Editing Method Please refer to FIGS. 5 and 6 for the explanation of the Visual Web Program (VWP) editing method. Since the main technique thought in the VWP editing method are similar to that of the VWP editing system described, only essential elements of the VWP editing method will be further described and other similar techniques are not repeated hereinafter.

As shown in FIG. 5, the VWP editing method includes an icon-generating procedure 1′, an icon-content generating procedure 2′, and a program-generating procedure 3′. The icon-generating procedure 1′ generates more than one icon for the program. The icon-content generating procedure 2′ generates the names and files of the icons.

The program-generating procedure 3′ generates a Web program according to the files of the icons generated by the icon-content generating procedure 2′.

It should be mentioned here that, in the disclosed VWP editing method, there is no particular order between the icon-generating procedure 1′ and the icon-content generating procedure 2′. In other words, the method can first generate the content of an icon and then generate a corresponding icon following the icon-generating procedure 1′.

Moreover, as shown in FIG. 6, the VWP editing method further includes a program-flowchart generating procedure 4′, which creates a program flowchart (FIG. 3) using the icons generated by the icon-generating procedure 1′.

Recording Medium

The invention further provides a recording medium stored with VWP editing software that is able to be executed in a computer. The procedures of the VWP editing software include: an icon-generating procedure 1′, an icon-content generating procedure 2′, and a program-generating procedure 3′. The icon-generating procedure 1′ generates more than one icon. The icon-content generating procedure 2′ generates the names and files of the icons. The program-generating procedure 3′ generates a Web program according to the files of the icons generated by the icon-content generating procedure 2′.

Of course, the disclosed VWP editing software can further run a program-flowchart generating procedure 4′, which creates a program flowchart (FIG. 3) using icons generated by the icon generating procedure 1′. In summary, the Visual Web Program editing system/method of the invention can create a plurality of icons by using the icon-generating module/procedure, generating the names and files of the icons through the icon-content generating module/procedure, whereby a Web program is produced. Therefore, the disclosed Visual Web Program editing system/method can provide a simple way for a programmer to write a program. It can decrease the coding complexity and lower the developmental cost of a Web application program.

Although the invention has been described with reference to specific embodiments, this description is not to be construed in a limited sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A Visual Web Program (VWP) editing system comprising:
an icon-generating module, which generates more than one icon;
an icon-content generating module, which generates names and files of the icons; and
a program-generating module, which generates a Web program according to the files of the icons generated by the icon-content generating module.

2. The system of claim 1 further comprising a program-flowchart generating module, which generates a program flowchart using icons generated by the icon-generating module.

3. The system of claim 1, wherein the icons comprise a Browser icon, an E-mail icon, and a Data Processing icon.

4. The system of claim 3, wherein the Browser icon comprises a Browser Form icon and a Browser Notification icon.

5. The system of claim 3, wherein the E-mail icon comprises an E-mail Form icon and an E-mail Notification icon.

6. The system of claim 1, wherein the file of the icon contains a program file written in an HTML-embedded programming language.

7. The system of claim 1, wherein the file of the icon contains a receiver-data file.

8. The system of claim 1, wherein the file of the icon contains a data-processing program file.

9. A Visual Web Program (VWP) editing method comprising:
an icon-generating procedure, which generates more than one icon;
an icon-content generating procedure, which generates names and files of the icons; and
a program-generating procedure, which generates a Web program according to the files of the icons generated by the icon-content generating module.

10. The method of claim 9 further comprising a program-flowchart generating procedure, which generates a program flowchart using icons generated by the icon-generating module.

11. The method of claim 9, wherein the program-flowchart icons comprise a Browser icon, an E-mail icon, and a Data Processing icon.

12. The method of claim 11, wherein the Browser icon comprises a Browser Form icon and a Browser Notification icon.

13. The method of claim 11, wherein the E-mail icon comprises an E-mail Form icon and an E-mail Notification icon.

14. The method of claim 9, wherein the file of the icon contains a program file written in an HTML-embedded programming language.

15. The method of claim 9, wherein the file of the icon contains a receiver-data file.

16. The method of claim 9, wherein the file of the icon contains a data-processing program file.

17. A recording medium stored with Visual Web Program (VWP) editing software able to be executed in a computer, the VWP editing software comprising:
an icon-generating procedure, which generates at least one program icon;
an icon-content generating procedure, which generates names and files of the icons;
a program-generating procedure, which generates a Web program according to the files of the icons generated by the icon-content generating module; and
a program-flowchart generating procedure, which generates a program flowchart using icons generated by the icon-generating procedure.
